(19) United States
(12) Patent Application Publication
(10) Pub. No.: US 2009/0204650 A1
(43) Pub. Date: Aug. 13, 2009

(54) File Deduplication using Copy-on-Write Storage Tiers

(75) Inventors: Thomas K. Wong, Pleasanton, CA (US); Ron S. Vogel, San Jose, CA (US)

Correspondence Address: Nixon Peabody LLP (F5 PATENTS);Gunnar G. Leinberg, 1100 Clinton Square, Rochester, NY, 14604, US

(73) Assignee: ATTUNE SYSTEMS, INC., Santa Clara, CA (US)

(21) Appl. No.: 12/268,575

(22) Filed: Nov. 11, 2008

Related U.S. Application Data
(60) Provisional application No. 60/988,269, filed on Nov. 15, 2007.
(60) Provisional application No. 60/988,306, filed on Nov. 15, 2007.

(51) Int. Cl. G06F 12/00; G06F 17/30; G06F 12/16

(52) U.S. Cl. 707/204; 707/206; 711/162; 711/E12.001; 711/E12.103; 711/E12.009; 707/E17.01; 707/E17.044

(57) ABSTRACT

A method and apparatus for removing duplicated data in a file system utilizing copy-on-write storage tiers. A synthetic namespace is created via file virtualization, and is comprised of one or more file systems. Deduplication is applied at the namespace level and on all of the file systems comprising the synthetic namespace. A set of storage policies selects a set of files from the namespace that become the candidates for deduplication. The entire chosen set is migrated to a Copy-On-Write (COW) storage tier. This Copy-On-Write storage tier may be a virtual storage tier that resides within another physical storage tier (such as tier-1 or tier-2 storage). Each file stored in a Copy-On-Write storage tier is deduped, regardless of whether there is any file with identical contents in the set or in the COW storage tier. After deduplication, the deduped file becomes a sparse file where all the files storage space is reclaimed while all the file's attributes, including size, remain. A copy of each file that is deduped is left as a mirror copy and is stored in a mirror server. If two mirror copies have identical contents, only one mirror copy will be stored in the mirror server. Read access to a file in the COW storage tier (COW file) is redirected to its mirror copy if the file is deduped. When the first write to a COW file is received, the mirror copy stored in the mirror server is copied as the contents of the COW file, and the association from the COW file to its mirror copy is discarded. Thereafter, access to the “un-deduped” file will resume normally from the COW file.

### CROSS-REFERENCE TO RELATED APPLICATIONS

This patent application claims priority from U.S. Provisional Patent Application No. 60/988,269 entitled FILE DEDUPLICATION USING COPY-ON-WRITE STORAGE TIERS filed on Nov. 15, 2007 (Attorney Docket No. 3193/125) and also claims priority from U.S. Provisional Patent Application No. 60/988,306 entitled FILE DEDUPLICATION USING A VIRTUAL COPY-ON-WRITE STORAGE TIER filed on Nov. 15, 2007 (Attorney Docket No. 3193/126).

This patent application also may be related to one or more of the following patent applications:

U.S. Provisional Patent Application No. 60/923,765 entitled NETWORK FILE MANAGEMENT SYSTEMS, APPARATUS, AND METHODS filed on Apr. 16, 2007 (Attorney Docket No. 3193/114).

U.S. Provisional Patent Application No. 60/940,104 entitled REMOTE FILE VIRTUALIZATION filed on May 25, 2007 (Attorney Docket No. 3193/116).

U.S. Provisional Patent Application No. 60/987,161 entitled REMOTE FILE VIRTUALIZATION METADATA MIRRORING filed Nov. 12, 2007 (Attorney Docket No. 3193/117).

U.S. Provisional Patent Application No. 60/987,165 entitled REMOTE FILE VIRTUALIZATION DATA MIRRORING filed Nov. 12, 2007 (Attorney Docket No. 3193/118).

U.S. Provisional Patent Application No. 60/987,170 entitled REMOTE FILE VIRTUALIZATION WITH NO EDGE SERVERS filed Nov. 12, 2007 (Attorney Docket No. 3193/119).

U.S. Provisional Patent Application No. 60/987,174 entitled LOAD SHARING CLUSTER FILE SYSTEM filed Nov. 12, 2007 (Attorney Docket No. 3193/120).

U.S. Provisional Patent Application No. 60/987,206 entitled NON-DISRUPTIVE FILE MIGRATION filed Nov. 12, 2007 (Attorney Docket No. 3193/121).

U.S. Provisional Patent Application No. 60/987,197 entitled HOTSPOT MITIGATION IN LOAD SHARING CLUSTER FILE SYSTEMS filed Nov. 12, 2007 (Attorney Docket No. 3193/122).

U.S. Provisional Patent Application No. 60/987,194 entitled ON DEMAND FILE VIRTUALIZATION FOR SERVER CONFIGURATION MANAGEMENT WITH LIMITED INTERRUPTION filed Nov. 12, 2007 (Attorney Docket No. 3193/123).

U.S. Provisional Patent Application No. 60/987,181 entitled FILE DEDUPLICATION USING STORAGE TIERS filed Nov. 12, 2007 (Attorney Docket No. 3193/124).

U.S. patent application Ser. No. 12/104,197 entitled FILE AGGREGATION IN A SWITCHED FILE SYSTEM filed Apr. 16, 2008 (Attorney Docket No. 3193/129).

U.S. patent application Ser. No. 12/103,989 entitled FILE AGGREGATION IN A SWITCHED FILE SYSTEM filed Apr. 16, 2008 (Attorney Docket No. 3193/130).

U.S. patent application Ser. No. 12/126,129 entitled REMOTE FILE VIRTUALIZATION IN A SWITCHED FILE SYSTEM filed May 23, 2008 (Attorney Docket No. 3193/131).

All of the above-referenced patent applications are hereby incorporated herein by reference in their entireties.

### FIELD OF THE INVENTION

This invention relates generally to storage networks, and more specifically, relates to file deduplication using copy-on-write storage tiers.

### BACKGROUND

In enterprises today, employees tend to keep copies of all of the necessary documents and data that they access often. This is so that they can find the documents and data easily (central locations tend to change at least every so often). Furthermore, employees also tend to forget where certain things were found (in the central location), or never even knew where the document originated (they are sent a copy of the document via email). Finally, multiple employees may each keep a copy of the latest mp3 file, or video file, even if it is against company policy.

This leads to duplicate copies of the same document or data residing in individually owned locations, so that the individual's themselves can easily find the document. However, this also means a lot of wasted space to store all of these copies of the document or data. And these copies are often stored on more expensive (and higher performance) tiers of storage, since the employees tend not to focus on costs, but rather on performance (they will store data on the location that they can most easily remember that gives them the best performance in retrieving the data).

Deduplication is a technique where files with identical contents are first identified and then only one copy of the identical contents, the single-instance copy, is kept in the physical storage while the storage space for the remaining identical contents is reclaimed and reused. Files whose contents have been deduped because of identical contents are hereafter referred to as deduplicated files. Thus, deduplication achieves what is called “Single-Instance Storage” where only the single-instance copy is stored in the physical storage, resulting in more efficient use of the physical storage space. File deduplication thus creates a domino effect of efficiency, reducing capital, administrative, and facility costs and is considered one of the most important and valuable technologies in storage.

U.S. Pat. Nos. 6,389,433 and 6,477,544 are examples of how a file system provides the single-instance-storage.

While single-instance-storage is conceptually simple, implementing it without sacrificing read/write performance is difficult. Files are deduped without the owners being aware of it. The owners of deduplicated files therefore have the same performance expectation as other files that have no duplicated copies. Since many deduplicated files are sharing one single-instance copy of the contents, it is important to prevent the single-instance copy from being modified. Typically, a file system uses the copy-on-write (COW) technique to protect the single-instance copy. When an update is pending on a deduplicated file, the file system creates a partial or full copy of the single-instance copy, and the update is allowed to proceed only after the (partial) copied data has been created and only on the copied data. The delay to wait for the creation of a (partial) copy of the single-instance data before an update can proceed introduces significant performance degradation. In addition, the process to identify and dedupe replicated files also puts a strain on file system resources. Because of the performance degradation, deduplication or single-instance copy is deemed not acceptable for normal use. In reality, deduplication is of no (obvious) benefit to the end-user. Thus, while the feature of deduplication or single-instance storage has been available in a few file systems, it is not commonly used and many file systems do not even offer this feature due to its adverse performance impact.

File system level deduplication offers many advantages for IT administrators. However, it generally offers no direct benefits to the users of the file system other than performance degradation for those files that have been deduped. Therefore, it would be desirable to reduce performance degradation to an acceptable level.

Another aspect of the file system level deduplication is that deduplication is usually done on a per file system basis. It is more desirable if deduplication is done together on one or more file systems. For example, the more file systems that are deduped together, the more chances that files with identical contents will be found and more storage space will be reclaimed. For example, if there is only one copy of file A in a file system, file A will not be deduped. On the other hand, if there is a copy of file A in another file system, then together, file A in the two file systems can be deduped. Furthermore, since there is only one single-instance copy for all of the deduplicated files from one or more file systems, the more file systems that are deduped together, the more efficient the deduplication process becomes.

The related application entitled File Deduplication Using Storage Tiers discloses a method of deduplication where duplicated files in one or more file servers in tier-1 storage are migrated to one or more file servers in tier-2 storage. As a result, the storage space occupied by duplicated files in tier-1 storage is reclaimed, while storage space in less expensive tier-2 storage is consumed for storing the duplicated files migrated from tier-1. Furthermore, a mirror copy from each set of duplicated files is left in the tier-1 storage for maintaining read performance. The performance degradation that exists on update operation on deduplicated file is eliminated since COW is not needed. While the deduplication method specified in the co-pending application does not actually save total storage space consumed by the duplicate files, it makes it easier for end-users to accept deduplication since they will experience, at most, a very minor inconvenience. Furthermore, the number of files in tier-1 storage is reduced by deduplication, resulting in faster backup of tier-1 file servers.

However, in some cases, the actual removal of all duplicated files is unlikely to cause any inconvenience to end-users. For example, the contents of music or image files are never changed once created and are therefore good candidates for deduplication. In another case, files that have not been accessed for a long time are also good candidates, since they are unlikely to be changed again any time soon.

Therefore, it would be desirable to provide deduplication of specified classes of files.

It would be desirable to achieve deduplication with acceptable performance. It is even more desirable to be able to dedupe across more file systems to achieve higher deduplication efficiency. Furthermore, to reduce inconvenience experienced by end-users due to the performance overhead of deduplication, deduplication itself should be able to be performed on a selected set of files, instead of on every file in one or more selected file servers. Finally, in the case where end-users are unlikely to experience inconvenience due to deduplication, deduplication should result in less utilization of storage space by eliminating the storage of identical file copies.

### SUMMARY OF THE INVENTION

In accordance with one aspect of the invention there is provided a method and file virtualization appliance for deduplicating files using copy-on-write storage tiers. Deduplicating files involves associating a number of files from the primary storage tier with a copy-on-write storage tier having a designated mirror server and deduplicating the files associated with the copy-on-write storage tier, such deduplicating including storing in the designated mirror server of the copy-on-write storage tier a single copy of the file contents for each duplicate and non-duplicate file associated with the copy-on-write storage tier; deleting the file contents from each deduplicated file in the copy-on-write storage tier to leave a sparse file; and storing metadata for each of the files, the metadata associating each sparse file with the corresponding single copy of the file contents stored in the designated mirror server.

In various alternative embodiments, associating a number of files from the primary storage tier with a copy-on-write storage tier may involve maintaining the copy-on-write storage tier separately from the primary storage tier and migrating the number of files from the primary storage tier to the copy-on-write storage tier. Maintaining the copy-on-write storage tier separately from the primary storage tier may involve creating a synthetic namespace for the copy-on-write storage tier using file virtualization, the synthetic namespace associated with a number of file servers, and wherein migrating the number of files from the primary storage tier to the copy-on-write storage tier comprises migrating a selected set of files from the synthetic namespace to the copy-on-write storage tier. Associating a number of files from the primary storage tier with a copy-on-write storage tier alternatively may involve marking the number of files as being associated with the copy-on-write storage tier, wherein the copy-on-write storage tier is a virtual copy-on-write storage tier. Associating a number of files from the primary storage tier with a copy-on-write storage tier may involve maintaining a set of storage policies identifying files to be associated with the copy-on-write storage tier and associating the number of files with the copy-on-write storage tier based on the set of storage policies. Storing a single copy of the file contents for each duplicate and non-duplicate file may involve determining whether the file contents of a selected file in the copy-on-write storage tier match the file contents of a previously deduplicated file having a single copy of file contents stored in the designated mirror server and when the file contents of the first selected file do not match the file contents of any previously deduplicated file, storing the file contents of the selected file in the designated mirror server. Determining whether the file contents of a selected file in the copy-on-write storage tier match the file contents of a previously deduplicated file having a single copy of file contents stored in the designated mirror server may involve comparing a hash value associated with the selected file to a hash values associated with the single copies of file contents for the previously deduplicated files stored in the designated mirror server.

Deduplicating files may further involve purging unused mirror copies from the designated mirror server. Purging unused mirror copies from the designated mirror server may involve suspending file deduplication operations; identifying mirror copies in the designated mirror server that are no longer in use; purging the unused mirror copies from the designated mirror server; and enabling file deduplication operations. Identifying mirror copies in the designated mirror server that are no longer in use may involve identifying mirror copies in the designated mirror server that are no longer associated with existing files associated with the copy-on-write storage tier. Identifying mirror copies in the designated mirror server that are no longer associated with existing files in the copy-on-write storage tier may involve constructing a list of hash values associated with existing files in the copy-on-write storage tier; and for each mirror copy in the designated mirror server, comparing a hash value associated with the mirror copy to the hash values in the list of hash values, wherein the mirror copy is deemed to be an unused mirror copy when the hash value associated with the mirror copy is not in the list of hash values.

The method may further involve processing open requests for files associated with the copy-on-write storage tier, such processing of open requests comprising:

receiving from a client an open request for a specified file associated with the copy-on-write storage tier;

when the specified file is a non-deduplicated file:
creating a copy-on-write file handle for the specified file;
marking the copy-on-write file handle as ready; and
returning the copy-on write file handle to the client;

when the specified file is a deduplicated file having a mirror copy of the file contents stored in the designated mirror server:
opening the specified file;
creating a copy-on-write file handle for the specified file;
marking the copy-on-write file handle as not ready;
returning the copy-on write file handle to the client;
when the open request is for read:
   obtaining a mirror file handle for the mirror copy from the designated mirror server;
   associating the mirror file handle with the copy-on-write file handle;
   opening the mirror copy;
   marking the copy-on-write handle as ready, if the open mirror copy is successful; and
   marking the copy-on-write handle as ready with error, if the open mirror copy is unsuccessful; and
when the open request is for update:
   filling the contents of the specified file from the mirror copy of the file contents stored in the designated mirror server; and
   marking the copy-on-write handle as ready.

The mirror file handle for the mirror copy may be obtained from the designated mirror server based on hash values associated with the specified file and the mirror copy.

The contents of the specified file may be filled from the copy of the file contents stored in the designated mirror server using a background task.

The method may further involve processing file requests for files associated with the copy-on-write storage tier. Such processing may involve:

receiving from the client a file request including the copy-on-write file handle;

when the copy-on-write file handle is marked as not ready:
suspending the file request until the contents of the specified file have been refilled from the mirror copy;
marking the copy-on-write file handle as ready if the contents of the specified file have been refilled successfully; and
marking the copy-on-write file handle as ready with error if the contents of the specified file have been refilled unsuccessfully;

when the copy-on-write file handle is marked as ready with error, returning an error indication to the client;

when the file request is a read operation and the copy-on-write file handle is associated with a mirror file handle:
using the mirror file handle to retrieve data from the mirror copy stored in the designated mirror server; and
returning the data to the client;

when the file request is a read operation and the copy-on-write file handle is not associated with a mirror file handle:
using the copy-on-write file handle to retrieve data from the file; and
returning the data to the client;

when the file request is a write operation, using the copy-on-write file handle to write data to the file in the copy-on-write storage tier; and

otherwise sending the file request to the file virtualization appliance.

### BRIEF DESCRIPTION OF THE DRAWINGS

The foregoing features of the invention will be more readily understood by reference to the following detailed description, taken with reference to the accompanying drawings, in which:

FIG. 1 is a schematic diagram showing an exemplary switched file system including a file virtualization appliance in the form of a file switch (MFM) as known in the art; and

FIG. 2 is a logic flow diagram for file deduplication using copy-on-write storage tiers in accordance with an exemplary embodiment of the present invention.

### DETAILED DESCRIPTION OF SPECIFIC EMBODIMENTS

Embodiments of the present invention relate generally to using a copy-on-write storage tier to reclaim storage space of all duplicated files and recreate the contents of a duplicated file from its mirror copy when an update is about to occur on the duplicated file.

A traditional file system manages the storage space by providing a hierarchical namespace. The hierarchical namespace starts from the root directory, which contains files and subdirectories. Each directory may also contain files and subdirectories identifying other files or subdirectories. Data is stored in files. Every file and directory is identified by a name. The full name of a file or directory is constructed by concatenating the name of the root directory and the names of each subdirectory that finally leads to the subdirectory containing the identified file or directory, together with the name of the file or the directory.

The full name of a file thus carries with it two pieces of information: (1) the identification of the file and (2) the physical storage location where the file is stored. If the physical storage location of a file is changed (for example, moved from one partition mounted on a system to another), the identification of the file changes as well.

For ease of management, as well as for a variety of other reasons, the administrator would like to control the physical storage location of a file. For example, important files might be stored on expensive, high-performance file servers, while less important files could be stored on less expensive and less capable file servers.

Unfortunately, moving files from one server to another usually changes the full name of the files and thus, their identification, as well. This is usually a very disruptive process, since after the move users may not be able to remember the new location of their files. Thus, it is desirable to separate the physical storage location of a file from its identification. With this separation, IT and system administrators will be able to control the physical storage location of a file while preserving what the user perceives as the location of the file (and thus its identity).

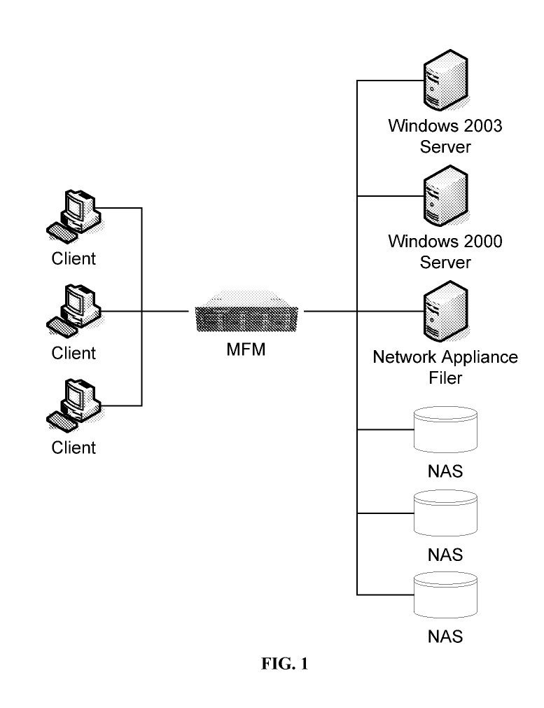

File virtualization is a technology that separates the full name of a file from its physical storage location. File virtualization is usually implemented as a hardware appliance that is physically or logically located in the data path between users and the file servers. For users, a file virtualization appliance appears as a file server that exports the namespace of a file system. From the file servers' perspective, the file virtualization appliance appears as just a normal user. Attune System's Maestro File Manager (MFM) is an example of a file virtualization appliance. FIG. 1 is a schematic diagram showing an exemplary switched file system including a file virtualization appliance in the form of a file switch (MFM).

As a result of separating the full name of a file from the file's physical storage location, file virtualization provides the following capabilities:
1) Creation of a synthetic namespace
   Once a file is virtualized, the full filename does not provide any information about where the file is actually stored. This leads to the creation of synthetic directories where the files in a single synthetic directory may be stored on different file servers. A synthetic namespace can also be created where the directories in the synthetic namespace may contain files or directories from a number of different file servers. Thus, file virtualization allows the creation of a single global namespace from a number of cooperating file servers. The synthetic namespace is not restricted to be from one file server, or one file system.
2) Allows having many full filenames to refer to a single file
   As a consequence of separating a file's name from the file's storage location, file virtualization also allows multiple full filenames to refer to a single file. This is important as it allows existing users to use the old filename while allowing new users to use a new name to access the same file.
3) Allows having one full name to refer to many files
   Another consequence of separating a file's name from the file's storage location is that one filename may refer to many files. Files that are identified by a single filename need not contain identical contents. If the files do contain identical contents, then one file is usually designated as the authoritative copy, while the other copies are called the mirror copies. Mirror copies increase the availability of the authoritative copy, since even if the file server containing the authoritative copy of a file is down, one of the mirror copies may be designated as a new authoritative copy and normal file access can then resumed. On the other hand, the contents of a file identified by a single name may change according to the identity of the user who wants to access the file.

Deduplication is of no obvious benefit to the end users of a file system. Exemplary embodiments of the present invention use deduplication as a storage placement policy to intelligently manage the storage assets of an enterprise, with relatively little inconvenience to end users.

Embodiments of the present invention utilize a Copy-On-Write (COW) storage tier in which every file in any of the file servers in the storage tier is eventually deduplicated, regardless whether there is any file in the storage tier that has identical contents. This is in contrast with the typical deduplication, where only files with identical contents are deduped.

Storage policies are typically used to limit the deduplication to only a set of files selected by the storage policies that apply to a synthetic namespace comprising one or more file servers. For example, one storage policy may migrate a specified class of files (e.g., all mp3 audio and jpeg image files) to a COW storage tier. Another example is that all files that have not been referenced for a specified period of time (e.g., over six months) are migrated to a COW storage tier. Once the files are in the COW storage tier, deduplication is done on every file, regardless whether any file with duplicated contents exists.

In an exemplary embodiment, extending file virtualization to support deduplication using the COW storage tier operates generally as follows. First, a synthetic namespace is created via file virtualization, and is comprised of one or more file servers. A set of storage policies is created that selects a set of files from the synthetic namespace to be migrated to the COW storage tier.

A set of file servers are selected to be in the COW storage tier. One of the file servers in a COW storage tier will also act as a mirror server. In exemplary embodiments, a mirror server is storage that may contain the current, past, or both current and past mirror copies of the authoritative copy of files stored at the COW storage tier. In exemplary embodiments, each mirror copy in the mirror sever is associated with a hash value, e.g., identified by a 160-bit number, which is the sha1 digest computed from the contents of the mirror copy. A sha1 digest value is a globally unique value for any given set of data (contents) of a file. Therefore, if two files are identical in contents (but not necessarily name or location), they should always have the same sha1 digest values. And conversely, if two files are different in contents, they should always have different sha1 digest values.

The mirror server is a special device. While it can be written, the writing of it is only performed by the file virtualization appliance itself, and each write to a file is only done once. Users and applications only read the contents of files stored on the mirror server. Basically, the mirror server is a sort of write once, read many (WORM) device. Therefore, if the mirror server were replicated, users and applications could read from any of the mirror servers available. By replicating the mirror server, one can increase the availability (if one mirror server is unavailable, another mirror server can service the request) and performance (multiple mirror servers can respond to reads from users and applications in parallel, as well as having mirror servers that are closest to the requester service the request).

Once a file is stored in a COW storage tier, the file will eventually be deduplicated. For example, if there is no update made to any files in a COW storage tier, then after a certain duration, all files in the COW storage tier will be deduped. After a file is deduped, the file becomes a sparse file where essentially all of the file's storage space is reclaimed while all of the file's attributes, including its size, remain.

A background deduplication process typically is run periodically within the file aggregation appliance to perform the deduplication. An exemplary deduplication process for a COW storage tier is as follows:
1) Each file stored in a COW storage tier is inspected.
2) If the file is not idle, the file is skipped, and the deduplication process proceeds with the next file stored in the COW storage tier.
3) If the file has already been deduped, the file is skipped, and the deduplication process proceeds with the next file stored in the COW storage tier.
4) If the file does not have a sha1 digest value, the value is computed and saved in the metadata for the file.
5) The file is deduped.
6) If the dedupe of the single file failed with an error code, then the deduplication process logs the full name of the single file together with the error code in a log file. The deduplication process will continue with the next file stored in the COW storage tier.
7) If the dedupe of the single file returned with a success code, then this algorithm loops around again with the next file. The deduplication process will continue until all the files in the COW storage are processed.

An exemplary process to dedupe a single file (called from the deduplication process for the namespace) is as follows:
1) The sha1 digest is retrieved from the metadata of the file.
2) A check is made to see if there is a mirror copy with an identical sha1 digest in the mirror server.
3) If there is no mirror copy in the mirror server, a new mirror copy is made with the sha1 digest and the file's contents. If there is no space on the mirror server for this new mirror copy, then this dedupe of a single file fails with an error code.
4) The storage space of the original file is released, resulting in a sparse file. The deduped file is marked as deduplicated, and the dedupe process returns with a success code.

When a file in COW storage tier is opened, the open request is actually sent to the MFM that manages the COW storage tier. An exemplary process to open a file is as follows:
1) Open the COW file. If the open is not successful, an error code is returned. The open operation is complete.
2) Otherwise, the file handle from opening a file in the COW storage tier is called the COW file handle. Notice that once a COW file is deduped, it becomes a sparse file and does not contain any data.
3) If the open of the COW file is successful and if the file is not a deduped file, the COW file handle is returned and the open operation is complete.
4) If the open of the file is successful and if the file is deduped, the COW file handle is marked as not ready and this handle is returned to the user. The open operation then continues as described below:
5) If the open is for read, then the sha1 digest is retrieved from the metadata and the sha1 digest for the file is then used to obtain a mirror file handle from the mirror server. If a mirror file handle is returned, the mirror file handle is associated with the COW file handle and the COW file handle is marked as ready.
6) If the open mirror file fails, the file is marked as ready (but with error). The open operation is complete.
7) If the open is for update, a background process will be informed to fill the contents of a COW file from the file's mirror copy stored in the mirror server. The open operation is complete.

When a file request is sent to the MFM, it includes a COW file handle. Exemplary steps for handling a file identified by the COW file handle are as follows:
1) If the COW file handle is marked as not ready, the request will be suspended until the COW file handle is ready (i.e. the file to be opened is made non-sparse, and the data from the mirror copy was copied into the original file in the COW storage).
2) If the COW file handle is marked as ready (but with error), an I/O error is returned.
3) If the request is a read operation and if the mirror file handle exists, the mirror file handle is used to retrieve the data. Otherwise, the COW file handle is used to retrieve the data. The result from either the COW file or the mirror server is returned to the user.
4) If the request is a write operation, the COW file handle is used to write the data to the COW storage.
5) If the request is an I/O control call sent from the background copy process informing that the contents of a COW file has been refilled from its mirror copy, the file is marked as ready. Otherwise, the file is marked as ready (but with error). Those suspended processes waiting for the not ready flag to be cleared will be woken up and their operations resumed.
6) Otherwise, all operations are sent to the MFM and processed by MFM.

As more mirror file copies are added into the mirror server, the past mirror file copies will need to be purged from the mirror server or the mirror server will eventually run out of storage space. An exemplary process to purge past mirror copies from the mirror server is as follows:
1) If the deduplication process is running, terminate that process and try again later.
2) Set up a lock to prevent the deduplication process from running.
3) Construct a list of in-use mirrors as follows:
   a) Each file stored in a COW storage tier is inspected.
   b) If the file is not idle, the file is skipped, and the purge process proceeds with the next file stored in the COW storage tier.
   c) If the file does not have a sha1 digest value, the file is skipped, and the purge process proceeds with the next file stored in the COW storage tier.
   d) Obtain the sha1 digest value from the file and add this value to the in-use mirror list.
   e) This algorithm loops around again with the next file. The purge process will continue until all the files in the COW storage are processed.
4) After the in-user mirror list is constructed, the process to locate and purge past mirror file copies from the mirror server is as follows:
   a) Each mirror copy stored in a COW storage tier is inspected.
   b) Obtain the sha1 digest value of the mirror.
   c) If the sha1 digest value is not found in the in-user mirror list, purge the mirror from the mirror server
   d) This algorithm loops around again with the next mirror. The purge process will continue until all of the mirror copies in the mirror server are processed.
5) The lock to prevent the deduplication process from running is released.

Some enterprises or locations may not have multiple storage tiers available to setup a copy-on-write storage tier, or not have enough available storage in an available tier to store the large amount of mp3 and image files that a storage policy would dictate be stored on the copy-on-write storage tier. A new storage tier is just that, a new storage tier to create and manage.

Therefore, an alternative embodiment removes the restriction that the copy-on-write storage tier is a separate and real physical storage tier. The copy-on-write storage tier may just be some part of another storage tier, such as tier-1 or tier-2 storage, thus becoming a virtual storage tier. Rather than copying files to an actual storage tier, files could be marked as a part of the virtual storage tier by virtue of a metadata flag, hereafter referred to as the COW flag. If the COW flag is false, the file is just a part of the storage tier the file resides within. If the COW flag is true, the file is not part of the storage tier the file resides within. Rather, the file is part of the virtual copy-on-write storage tier.

Some advantages of this approach are that the files need not be copied to a physical tier of storage first, before deduplication. Furthermore, the IT administrator continues to just manage a single tier (or the same number of tiers as they were managing previously).

In addition to these advantages, all of the advantages of a physically separate COW tier discussed above generally continue to hold, including achieving deduplication with acceptable performance, the ability to dedupe across more file systems to achieve higher deduplication efficiency, and reducing the inconvenience experienced by end-users due to the performance overhead of deduplication based on a storage policy of deduping a selected set of files, while still resulting in less utilization of storage space by eliminating the storage of identical file copies.

As before, every file within the virtual copy-on-write storage tier will eventually be deduped, regardless whether there is any file in the virtual storage tier that has identical contents. This is in contrast with the typical deduplication, where only files with identical contents are deduped.

As above, a set of storage policies is created that selects a set of files from the synthetic namespace to be migrated to the virtual COW storage tier. If the files already reside on the tier which co-resides with the virtual COW storage tier, then no actual migration is performed. Rather, the COW flag within the metadata indicating that the file has been migrated to the virtual COW storage tier is set. If the file resides on a different storage tier than the virtual COW storage tier, then a physical migration is performed to the COW storage tier. Again, the COW flag within the metadata indicating that the file has been migrated to the virtual COW storage tier is set.

Alternatively, there may be a single virtual COW storage tier for all physical storage tiers within the namespace. In this case, when a storage policy indicates that a file should be migrated to the virtual COW storage tier, no physical migration is ever performed. The COW flag within the metadata indicating that the file has been migrated to the virtual COW storage is set. In this way, there generally is no need to select a set of file servers to be in the COW storage tier.

There is still the need to select one of the file servers to act as a mirror server.

Once a file is stored in the virtual COW storage tier, the file will eventually be deduped. In other words, if there is no update made to any files in a virtual COW storage tier, then after a certain duration, all files in the virtual COW storage tier will be deduped. After a file is deduped, the file becomes a sparse file where all of the file's storage space is reclaimed while all of the file's attributes, including its size, remain. Since the file just resides within a regular storage tier, the storage space that is reclaimed is the valuable tier storage space the file used to occupy.

As above, a background deduplication process typically is run periodically within the MFM to perform the deduplication. An exemplary deduplication process for a virtual COW storage tier is as follows:
1) Each file stored in the storage tier (or namespace) is inspected.
2) If the file is not in the virtual COW storage tier as indicated by the COW flag in the metadata, then the file is skipped, and the deduplication process proceeds with the next file stored in the storage tier (or namespace).
3) If the file is not idle, the file is skipped, and the deduplication process proceeds with the next file stored in the storage tier (or namespace).
4) If the file has already been deduped, the file is skipped, and the deduplication process proceeds with the next file stored in the storage tier (or namespace).
5) If the file does not have a sha1 digest value, the value is computed and saved in the metadata for the file.
6) The file is deduped.
7) If the dedupe of the single file failed with an error code, then the deduplication process logs the full name of the single file together with the error code in a log file. The deduplication process will continue with the next file stored in the storage tier (or namespace).
8) If the dedupe of the single file returned with a success code, then this algorithm loops around again with the next file. The deduplication process will continue until all the files in the storage tier (or namespace) are processed.

An exemplary process to dedupe a single file (as called by the deduplication process above) is essentially unchanged from the process described above. An exemplary process to dedupe a single file is as follows:
1) The sha1 digest is retrieved from the metadata of the file.
2) A check is made to see if there is a mirror copy with an identical sha1 digest in the mirror server.
3) If there is no mirror copy in the mirror server, a new mirror copy is made with the sha1 digest and the file's contents. If there is no space on the mirror server for this new mirror copy, then this dedupe of a single file fails with an error code.
4) The storage space of the original file is released, resulting in a sparse file. The deduped file is marked as deduplicated, and the dedupe process returns with a success code.

When a file is opened, the open request is actually sent to an MFM that manages the partition of the namespace. An exemplary process to open a file is as follows:
1) Determine if this is a COW file by checking the COW flag indicating if this file is part of the virtual COW storage tier. If not, return the results of the normal open call.
2) Open the COW file. If the open is not successful, an error code is returned. The open operation is complete.
3) Otherwise, the file handle from opening a file in the virtual COW storage tier is called the COW file handle. Notice that once a COW file is deduped, it becomes a sparse file and does not contain any data. Also notice that this COW file handle is really the normal file handle for opening the file in its normal place.
4) If the open of the COW file is successful and if the file is not a deduped file, the COW file handle is returned and the open operation is complete.
5) If the open of the file is successful and if the file is deduped, the COW file handle is marked as not ready and this handle is returned to the user. The open operation then continues as described below:
6) If the open is for read, then the sha1 digest is retrieved from the metadata and the sha1 digest for the file is then used to obtain a mirror file handle from the mirror server. If a mirror file handle is returned, the mirror file handle is associated with the COW file handle and the COW file handle is marked as ready. If the open mirror file fails, the file is marked as ready (but with error). The open operation is complete.
7) If the open is for update, a background process will be informed to fill the contents of a COW file from the file's mirror copy stored in the mirror server. The open operation is complete.

When a file request is sent to the MFM, it must include a file handle. Exemplary steps for handling a file are as follows:
1) If the file is a COW file (determined by checking the COW flag indicating COW storage tier), then continue using the file handle as the COW file handle. Otherwise, handle the file request as normal.
2) If the COW file handle is marked as not ready, the request will be suspended until the COW file handle is ready (i.e. the file to be opened is made non-sparse, and the data from the mirror copy was copied into the original file in the COW storage).
3) If the COW file handle is marked as ready (but with error), an I/O error is returned.
4) If the request is a read operation and if the mirror file handle exists, the mirror file handle is used to retrieve the data. Otherwise, the COW file handle is used to retrieve the data. The result from either the COW file or the mirror server is returned to the user.
5) If the request is a write operation, the COW file handle is used to write the data to the COW storage.
6) If the request is an I/O control call sent from the background copy process informing that the contents of a COW file has been refilled from its mirror copy, the file is marked as ready. Otherwise, the file is marked as ready (but with error). Those suspended processes waiting for the not ready flag to be cleared will be woken up and their operations resumed.
7) Otherwise, all operations are sent to the MFM and processed by the MFM.

As more mirror file copies are added into the mirror server, the past mirror file copies will need to be purged from the mirror server or the mirror server will eventually run out of storage space. An exemplary process to purge past mirror copies from the mirror server is as follows:
1) If the deduplication process is running, terminate the purge past mirror process and try again later.
2) Set up a lock to prevent the deduplication process from running.
3) Construct a list of in-use mirrors as follows:
   a) Each file stored in the storage tier or namespace is inspected
   b) If the file is not part of the virtual COW storage tier, the file is skipped, and the purge process proceeds with the next file in the storage tier (or namespace)
   c) If the file is not idle, the file is skipped, and the purge process proceeds with the next file stored in the storage tier (or namespace).
   d) If the file does not have a sha1 digest value, the file is skipped, and the purge process proceeds with the next file stored in the storage tier (or namespace).
   e) Obtain the sha1 digest value from the file and add this value to the in-use mirror list.
   f) This algorithm loops around again with the next file. The purge process will continue until all the files in the storage tier (or namespace) are processed.
4) After the in-user mirror list is constructed, the process to locate and purge past mirror file copies from the mirror server is performed as indicated in the co-patent application File Deduplication Using Copy-On-Write Storage Tiers:
   a) Each mirror copy stored in a mirror server is inspected.
   b) Obtain the sha1 digest value of the mirror.
   c) If the sha1 digest value is not found in the in-use mirror list, purge the mirror from the mirror server
   d) This algorithm loops around again with the next mirror. The purge process will continue until all of the mirror copies in the mirror server are processed.
5) The lock to prevent the deduplication process from running is released.

It should be noted that the in-user mirror list in an actual embodiment may be implemented as a hash table, a binary tree, or using other data structures commonly used by the people skilled in the art to achieve acceptable find performance.

As described here, it is still possible that the mirror server completely fills up (even though past mirror copies are purged). Therefore, the mirror server should be as large as possible, to accommodate at least one copy of all files that can exist in the COW storage tier. Otherwise, the mirror server may run out of space, and further deduplication will not be possible.

The related application entitled Remote File Virtualization Data Mirroring, a mechanism to purge mirror copies from the mirror server (any mirror copy can be purged at any given time, since an authoritative copy exists elsewhere) discusses a process for purging past mirror copies from the mirror server. Such purging of in-use mirror copies generally cannot be used in embodiments of the present invention. This is because a file that has been deduped in the COW storage tier only exists as a sparse file (no data in the file) and as a mirror copy. Thus, the mirror copy is actually the authoritative copy of the data contents of the deduped file. An in-use mirror copy is not purged because, among other things, it is difficult to locate and restore the contents of all the COW files that have the same identical mirror copy.

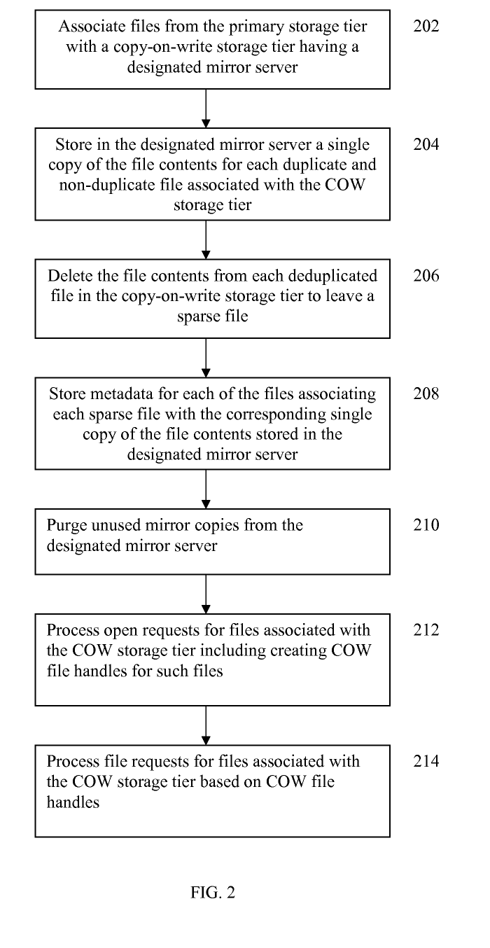

FIG. 2 is a logic flow diagram for file deduplication using copy-on-write storage tiers in accordance with an exemplary embodiment of the present invention. In block 202, the file virtualization appliance associates a number of files from the primary storage tier with a copy-on-write storage tier having a designated mirror server. In block 204, the file virtualization appliance stores in the designated mirror server a single copy of the file contents for each duplicate and non-duplicate file associated with the copy-on-write storage tier. In block 206, the file virtualization appliance deletes the file contents from each deduplicated file in the copy-on-write storage tier to leave a sparse file. In block 208, the file virtualization appliance stores metadata for each of the files, the metadata associating each sparse file with the corresponding single copy of the file contents stored in the designated mirror server. In block 210, the file virtualization appliance purges unused mirror copies from the designated mirror server from time to time. In block 212, the file virtualization appliance processes open requests for files associated with the copy-on-write storage tier including creating COW files handles for such files. In block 214, the file virtualization appliance processes file requests for files associated with the COW storage tier based on COW file handles.

It should be noted that file deduplication as discussed herein may be implemented using a file switches of the types described above and in the provisional patent application referred to by Attorney Docket No. 3193/114. It should also be noted that embodiments of the present invention may incorporate, utilize, supplement, or be combined with various features described in one or more of the other referenced patent applications.

It should be noted that terms such as “client,” “server,” “switch,” and “node” may be used herein to describe devices that may be used in certain embodiments of the present invention and should not be construed to limit the present invention to any particular device type unless the context otherwise requires. Thus, a device may include, without limitation, a bridge, router, bridge-router (brouter), switch, node, server, computer, appliance, or other type of device. Such devices typically include one or more network interfaces for communicating over a communication network and a processor (e.g., a microprocessor with memory and other peripherals and/or application-specific hardware) configured accordingly to perform device functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the described logic is implemented as a set of computer program instructions that is converted into a computer executable form, stored as such in a computer readable medium, and executed by a microprocessor under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A method of deduplicating files from a primary storage tier by a file virtualization appliance in a file storage system, the method comprising:
associating a number of files from the primary storage tier with a copy-on-write storage tier having a designated mirror server; and
deduplicating the files associated with the copy-on-write storage tier, such deduplicating including:
storing in the designated mirror server a single copy of the file contents for each duplicate and non-duplicate file associated with the copy-on-write storage tier;
deleting the file contents from each deduplicated file in the copy-on-write storage tier to leave a sparse file; and
storing metadata for each of the files, the metadata associating each sparse file with the corresponding single copy of the file contents stored in the designated mirror server.

2. A method according to claim 1, wherein associating a number of files from the primary storage tier with a copy-on-write storage tier comprises:
maintaining the copy-on-write storage tier separately from the primary storage tier; and
migrating the number of files from the primary storage tier to the copy-on-write storage tier.

3. A method according to claim 2, wherein maintaining the copy-on-write storage tier separately from the primary storage tier comprises creating a synthetic namespace for the copy-on-write storage tier using file virtualization, the synthetic namespace associated with a number of file servers, and wherein migrating the number of files from the primary storage tier to the copy-on-write storage tier comprises migrating a selected set of files from the synthetic namespace to the copy-on-write storage tier.

4. A method according to claim 1, wherein associating a number of files from the primary storage tier with a copy-on-write storage tier comprises:
marking the number of files as being associated with the copy-on-write storage tier, wherein the copy-on-write storage tier is a virtual copy-on-write storage tier.

5. A method according to claim 1, wherein associating a number of files from the primary storage tier with a copy-on-write storage tier comprises:
maintaining a set of storage policies identifying files to be associated with the copy-on-write storage tier; and
associating the number of files with the copy-on-write storage tier based on the set of storage policies.

6. A method according to claim 1, wherein storing in the designated mirror server a single copy of the file contents for each duplicate and non-duplicate file associated with the copy-on-write storage tier comprises:
determining whether the file contents of a selected file in the copy-on-write storage tier match the file contents of a previously deduplicated file having a single copy of file contents stored in the designated mirror server; and
when the file contents of the first selected file do not match the file contents of any previously deduplicated file, storing the file contents of the selected file in the designated mirror server.

7. A method according to claim 6, wherein determining whether the file contents of a selected file in the copy-on-write storage tier match the file contents of a previously deduplicated file having a single copy of file contents stored in the designated mirror server comprises:
comparing a hash value associated with the selected file to hash values associated with the single copies of file contents for the previously deduplicated files stored in the designated mirror server.

8. A method according to claim 1, further comprising:
purging unused mirror copies from the designated mirror server.

9. A method according to claim 8, wherein purging unused mirror copies from the designated mirror server comprises:
suspending file deduplication operations;
identifying mirror copies in the designated mirror server that are no longer in use;
purging the unused mirror copies from the designated mirror server; and
enabling file deduplication operations.

10. A method according to claim 9, wherein identifying mirror copies in the designated mirror server that are no longer in use comprises:
identifying mirror copies in the designated mirror server that are no longer associated with existing files associated with the copy-on-write storage tier.

11. A method according to claim 10, wherein identifying mirror copies in the designated mirror server that are no longer associated with existing files in the copy-on-write storage tier comprises:
constructing a list of hash values associated with existing files in the copy-on-write storage tier; and
for each mirror copy in the designated mirror server, comparing a hash value associated with the mirror copy to the hash values in the list of hash values, wherein the mirror copy is deemed to be an unused mirror copy when the hash value associated with the mirror copy is not in the list of hash values.

12. A method according to claim 1, further comprising:
receiving from a client an open request for a specified file associated with the copy-on-write storage tier;
when the specified file is a non-deduplicated file:
creating a copy-on-write file handle for the specified file;
marking the copy-on-write file handle as ready; and
returning the copy-on write file handle to the client;
when the specified file is a deduplicated file having a mirror copy of the file contents stored in the designated mirror server:
opening the specified file;
creating a copy-on-write file handle for the specified file;
marking the copy-on-write file handle as not ready;
returning the copy-on write file handle to the client;
when the open request is for read:
obtaining a mirror file handle for the mirror copy from the designated mirror server;
associating the mirror file handle with the copy-on-write file handle;
opening the mirror copy;
marking the copy-on-write handle as ready, if the open mirror copy is successful; and
marking the copy-on-write handle as ready with error, if the open mirror copy is unsuccessful; and
when the open request is for update:
filling the contents of the specified file from the mirror copy of the file contents stored in the designated mirror server; and
marking the copy-on-write handle as ready.

13. A method according to claim 12, wherein the mirror file handle for the mirror copy is obtained from the designated mirror server based on hash values associated with the specified file and the mirror copy.

14. A method according to claim 12, wherein the contents of the specified file are filled from the copy of the file contents stored in the designated mirror server by a background task.

15. A method according to claim 12, further comprising:
receiving from the client a file request including the copy-on-write file handle;
when the copy-on-write file handle is marked as not ready:
suspending the file request until the contents of the specified file have been refilled from the mirror copy;
marking the copy-on-write file handle as ready if the contents of the specified file have been refilled successfully; and
marking the copy-on-write file handle as ready with error if the contents of the specified file have been refilled unsuccessfully;
when the copy-on-write file handle is marked as ready with error, returning an error indication to the client;
when the file request is a read operation and the copy-on-write file handle is associated with a mirror file handle:
using the mirror file handle to retrieve data from the mirror copy stored in the designated mirror server; and
returning the data to the client;
when the file request is a read operation and the copy-on-write file handle is not associated with a mirror file handle:
using the copy-on-write file handle to retrieve data from the file; and
returning the data to the client;
when the file request is a write operation, using the copy-on-write file handle to write data to the file in the copy-on-write storage tier; and
otherwise sending the file request to the file virtualization appliance.

16. A file virtualization appliance for deduplicating files from a primary storage tier in a file storage system, the file virtualization appliance comprising:
a network interface for communication with the file servers; and
a processor coupled to the network interface and configured to associate a number of files from the primary storage tier with a copy-on-write storage tier having a designated mirror server and to deduplicate the files associated with the copy-on-write storage tier, such deduplicating including:
storing in the designated mirror server a single copy of the file contents for each duplicate and non-duplicate file associated with the copy-on-write storage tier;
deleting the file contents from each deduplicated file in the copy-on-write storage tier to leave a sparse file; and
storing metadata for each of the files, the metadata associating each sparse file with the corresponding single copy of the file contents stored in the designated mirror server.

17. A file virtualization appliance according to claim 16, wherein the processor is configured to associate a number of files from the primary storage tier with a copy-on-write storage tier by maintaining the copy-on-write storage tier separately from the primary storage tier and migrating the number of files from the primary storage tier to the copy-on-write storage tier.

18. A file virtualization appliance according to claim 17, wherein the processor is configured to maintain the copy-on-write storage tier separately from the primary storage tier by creating a synthetic namespace for the copy-on-write storage tier using file virtualization, the synthetic namespace associated with a number of file servers, and wherein migrating the number of files from the primary storage tier to the copy-on-write storage tier comprises migrating a selected set of files from the synthetic namespace to the copy-on-write storage tier.

19. A file virtualization appliance according to claim 16, wherein the processor is configured to associate a number of files from the primary storage tier with a copy-on-write storage tier by marking the number of files as being associated with the copy-on-write storage tier, wherein the copy-on-write storage tier is a virtual copy-on-write storage tier.

20. A file virtualization appliance according to claim 16, wherein the processor is configured to associate a number of files from the primary storage tier with a copy-on-write storage tier by maintaining a set of storage policies identifying files to be associated with the copy-on-write storage tier and associating the number of files with the copy-on-write storage tier based on the set of storage policies.

21. A file virtualization appliance according to claim 16, wherein the processor is configured to store a single copy of the file contents for each duplicate and non-duplicate file associated with the copy-on-write storage tier by determining whether the file contents of a selected file in the copy-on-write storage tier match the file contents of a previously deduplicated file having a single copy of file contents stored in the designated mirror server and when the file contents of the first selected file do not match the file contents of any previously deduplicated file, storing the file contents of the selected file in the designated mirror server.

22. A file virtualization appliance according to claim 21, wherein the processor is configured to determine whether the file contents of a selected file in the copy-on-write storage tier match the file contents of a previously deduplicated file having a single copy of file contents stored in the designated mirror server by comparing a hash value associated with the selected file to hash values associated with the single copies of file contents for the previously deduplicated files stored in the designated mirror server.

23. A file virtualization appliance according to claim 16, wherein the processor is further configured to purge unused mirror copies from the designated mirror server.

24. A file virtualization appliance according to claim 23, wherein the processor is configured to purge unused mirror copies from the designated mirror server by suspending file deduplication operations; identifying mirror copies in the designated mirror server that are no longer in use; purging the unused mirror copies from the designated mirror server; and enabling file deduplication operations.

25. A file virtualization appliance according to claim 24, wherein the processor is configured to identify mirror copies in the designated mirror server that are no longer in use by identifying mirror copies in the designated mirror server that are no longer associated with existing files associated with the copy-on-write storage tier.

26. A file virtualization appliance according to claim 25, wherein the processor is configured to identify mirror copies in the designated mirror server that are no longer associated with existing files in the copy-on-write storage tier by constructing a list of hash values associated with existing files in the copy-on-write storage tier and for each mirror copy in the designated mirror server, comparing a hash value associated with the mirror copy to the hash values in the list of hash values, wherein the mirror copy is deemed to be an unused mirror copy when the hash value associated with the mirror copy is not in the list of hash values.

27. A method according to claim 16, wherein the processor is further configured to process open requests for files associated with the copy-on-write storage tier, such processing of open requests comprising:
receiving from a client an open request for a specified file associated with the copy-on-write storage tier;
when the specified file is a non-deduplicated file:
creating a copy-on-write file handle for the specified file;
marking the copy-on-write file handle as ready; and
returning the copy-on write file handle to the client;
when the specified file is a deduplicated file having a mirror copy of the file contents stored in the designated mirror server:
opening the specified file;
creating a copy-on-write file handle for the specified file;
marking the copy-on-write file handle as not ready;
returning the copy-on write file handle to the client;
when the open request is for read:
obtaining a mirror file handle for the mirror copy from the designated mirror server;
associating the mirror file handle with the copy-on-write file handle;
opening the mirror copy;
marking the copy-on-write handle as ready, if the open mirror copy is successful; and
marking the copy-on-write handle as ready with error, if the open mirror copy is unsuccessful; and
when the open request is for update:
filling the contents of the specified file from the mirror copy of the file contents stored in the designated mirror server; and
marking the copy-on-write handle as ready.

28. A method according to claim 27, wherein the processor is configured to obtain the mirror file handle for the mirror copy from the designated mirror server based on hash values associated with the specified file and the mirror copy.

29. A method according to claim 27, wherein the processor is configured to fill the contents of the specified file from the copy of the file contents stored in the designated mirror server using a background task.

30. A method according to claim 27, wherein the processor is further configured to process file requests, such processing of file requests comprising:
receiving from the client a file request including the copy-on-write file handle;
when the copy-on-write file handle is marked as not ready:
suspending the file request until the contents of the specified file have been refilled from the mirror copy;
marking the copy-on-write file handle as ready if the contents of the specified file have been refilled successfully; and
marking the copy-on-write file handle as ready with error if the contents of the specified file have been refilled unsuccessfully;
when the copy-on-write file handle is marked as ready with error, returning an error indication to the client;
when the file request is a read operation and the copy-on-write file handle is associated with a mirror file handle:
using the mirror file handle to retrieve data from the mirror copy stored in the designated mirror server; and
returning the data to the client;
when the file request is a read operation and the copy-on-write file handle is not associated with a mirror file handle:
using the copy-on-write file handle to retrieve data from the file; and
returning the data to the client;
when the file request is a write operation, using the copy-on-write file handle to write data to the file in the copy-on-write storage tier; and
otherwise sending the file request to the file virtualization appliance.
